(19) United States
(12) Patent Application Publication
(10) Pub. No.: US 2010/0056004 A1
(43) Pub. Date: Mar. 4, 2010

(54) Skid resistant roof underlayment

(76) Inventors: Jennifer Marie Galvin, Nashville, TN (US); Arturo Horta, Chadds Ford, PA (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 12/073,000

(22) Filed: Feb. 29, 2008

Related U.S. Application Data
(60) Provisional application No. 60/905,122, filed on Mar. 5, 2007.

(51) Int. Cl. D04H 3/16; B32B 27/02

(52) U.S. Cl. 442/101

(57) ABSTRACT

A flexible, non-skid roof underlayment is provided which is formed from a spunbond nonwoven layer of continuous multiple component filaments and a coating on at least one surface of the spunbond nonwoven layer. The spunbond filaments are preferably formed in a sheath-core configuration with a high strength component in the core and a sheath component having high adhesion to the coating. The roof underlayment has an improved combination of high tensile strength and high coefficient of friction.

### BACKGROUND OF THE INVENTION

1. Field of the Invention

This invention relates to a non-skid roof underlayment having a high coefficient of friction and high tensile strength.

2. Description of the Related Art

Polymeric nonwoven sheet materials coated with a polymer coating are known for use as flexible roof underlayments. However, the coating polymers used are limited to those polymers which have good adhesion to the polymers of the nonwoven sheets. As a consequence, when high strength nonwoven substrates are used, the polymer coatings used have an undesirably low coefficient of friction resulting in a roof underlayment on which a person may skid or slide when walking on the underlayment during roof installations and repairs.

There is a need for a flexible, non-skid roof underlayment that provides an improved combination of high tensile strength and high coefficient of friction.

### DETAILED DESCRIPTION OF THE INVENTION

The terms “spunbond nonwoven,” “spunbond layer,” “spunbond nonwoven fabric” and “spunbond nonwoven web” are used interchangeably herein to refer to a nonwoven sheet formed from melt spun continuous filaments also referred to as “spunbond fibers” or “spunbond filaments.” The term “spunbond” filaments as used herein means filaments which are formed by extruding molten thermoplastic polymer material as filaments from a plurality of fine capillaries of a spinneret with the diameter of the extruded filaments then being rapidly reduced by drawing. Spunbond filaments are generally continuous and usually have an average diameter of greater than about 5 microns. Spunbond nonwoven fabrics are formed by laying spunbond filaments randomly on a collecting surface such as a foraminous screen or belt. Spunbond webs can be bonded by methods known in the art such as thermal calendering, through air bonding, or by passing the web through a saturated-steam chamber at an elevated pressure.

The term “nonwoven” means a web including a multitude of randomly distributed fibers. The fibers generally can be bonded to each other or can be unbonded. The fibers can comprise a single component or multitude components.

The terms “multiple component filament” and “multiple component fiber” as used herein refer to any filament or fiber that is composed of at least two distinct polymers which have been spun together to form a single filament or fiber. The multiple component fibers or filaments are bicomponent fibers or filaments which are made from two distinct polymers arranged in distinct zones across the cross-section of the multiple component fibers and extending along the length of the fibers. Multiple component fibers are distinguished from fibers which are extruded from a homogeneous melt blend of polymeric materials. Multiple component fibers useful in the invention are referably sheath-core fibers. The multiple component continuous filament spunbond webs useful in the current invention can be prepared using spunbonding methods known in the art. Spunbond filaments are generally round but can be made in a variety of other shapes (e.g. oval, tri-lobal or multi-lobal, flat, hollow, etc.) and configurations (e.g. symmetrical sheath-core, eccentric sheath-core, etc.).

“Calendering” is the process of passing a web through a nip between two rolls. The rolls may be in contact with each other, or there may be a fixed or variable gap between the roll surfaces. The rolls of the nip may be “soft,” i.e., having a surface which deforms under applied pressure, or “hard,” i.e., having a surface in which no deformation occurs under applied pressure during the calendering process. The rolls of the nip may be patterned, i.e., having no points or patterns to deliberately produce a pattern on the web as it passed through the nip. “Point bonding” is the process of passing a web through a nip between two rolls having a pattern to bond the web at discrete points. Alternatively, the rolls may be unpatterned, i.e., having a smooth surface. “Area bonding” is the process of passing the web through a nip between two smooth rolls.

By “roof underlayment” or “underlayment” is meant any sheet material that is incorporated in the roofing of a building to cover or protect some area of the building from weather or other factors in the environment outside the building.

The term “outer” when used to describe the location of a layer refers to the side or surface of the underlayment that faces away form the building. The term “inner” refers to the side of the underlayment that faces towards the building.

In one embodiment, the invention is directed to a roof underlayment having the ability to maintain a high coefficient of friction, a high grab tensile strength, and a high resistance to liquid water penetration, which is also referred to herein interchangeably as “hydrostatic head,” “hydrohead,” and “liquid water resistance.” The underlayment may contain a spunbond nonwoven web layer that in turn is formed of continuous polymeric sheath-core fibers. The sheath component advantageously comprises polyethylene and the core component advantageously comprises a polymer selected from the group consisting of polyesters and polyamides. The weight ratio of sheath component to core component is advantageously between about 10:90 and 90:10. The basis weight of the spunbond web can be between about 50 g/m² and about 136 g/m².

The underlayment of the invention further has a coefficient of friction of at least 0.40, the roof underlayment has a tensile strength of at least 26 N/cm in the machine direction and a hydrostatic head of at least 100 cm of water. The coefficient of friction is preferably obtained by use of suitable coatings rather than the use of gritty materials such as sand, coal slag and the like as disclosed in US 2006/0228963.

The spunbond nonwoven layer can be formed primarily or exclusively from multiple component spunbond fibers produced by melt spinning, such as illustrated in U.S. Pat. Nos. 6,831,025 and 7,008,888, incorporated herein in their entirety. Such bicomponent spunbond fibers have been found to be particularly well suited for use in the substrate of the roof underlayment of the invention since the bicomponent fibers can be tailored to combine a core component that provides high tensile strength with a sheath component that provides high adhesion with the underlayment coating polymer. Suitable polymers for use as a core component may include polypropylene, polyesters and polyamides. Suitable polymers for use as the sheath component may include polyolefins, such as polyethylene and polypropylene, and copolymers thereof. The weight ratio of the sheath component to the core component is between about 10:90 and 90:10. The polymer of the sheath and/or core can include other conventional additives such as dyes, pigments, antioxidants, UV stabilizers, spin finishes, and the like.

The spunbond nonwoven layer can be calendered, either by area bonding or point bonding, in order to impart the desired physical properties to the underlayment of the invention. The spunbond nonwoven layer can be fed into a calender nip between two rolls in which at least one roll is maintained at a temperature that is between the temperature at which the polymer undergoes a transition from glassy to rubbery state and the temperature of the onset of melting of the polymer, such that the fibers of the spunbond nonwoven layer are in a plasticized state when passing through the calender nip. The composition and hardness of the rolls can be varied to yield the desired end use properties of the fabric. The residence time of the spunbond nonwoven layer in the nip between the two rolls is controlled by the line speed of the web. The bonding conditions such as line speed, temperature and pressure may be varied as would be apparent to one skilled in the art.

The spunbond nonwoven layer is coated by a known coating means such as extrusion coating. Suitable polymers for use as the coating include polyethylene, ethylene methyl-acrylate copolymer, ethylene ethyl-acrylate copolymer, and ethylene butyl-acrylate copolymer resins. The coating resin can include other conventional additives such as dyes, pigments, antioxidants, UV stabilizers, and the like.

### EXAMPLES

In the description above and in the examples that follow, the following test methods were employed to determine various reported characteristics and properties. ASTM refers to the American Society for Testing and Materials. TAPPI refers to the Technical Association of the Pulp and Paper Industry.

Basis weight is a measure of the mass per unit area of a fabric or sheet and was determined by ASTM D-3776, which is hereby incorporated by reference, and is reported in g/m².

Coefficient of friction was determined according to TAPPI 815.

Hydrostatic head was determined according to AATCC-127. The results were measured in centimeters of water.

Tensile strength in the machine direction and cross direction was determined according to ASTM D412, or according to ASTM D5034-95, as noted in Table 1. The results according to method D412 were measured in lb/in and converted to N/cm, and the results according to method D5034-95 were measured in lb_{f} and converted to N.

### Examples 1-10

These non-limiting examples demonstrate the preparation of a roofing underlayment made by coating a polymer layer onto the top and bottom sides of a spunbond layer. The spunbond layer was formed from sheath-core spunbond fibers prepared in a bicomponent spunbond process using linear low density polyethylene (LLDPE) with a melting point of about 126° C. as the sheath component, and polyethylene terephthalate (PET) with a melting point of about 260° C. and an intrinsic viscosity of 0.64 as the core component. The PET resin was crystallized and dried before use. The PET and LLDPE polymers were heated and extruded in separate extruders, filtered and metered to a bicomponent spin block designed to provide a sheath-core filament cross section. The polymers were metered to provide fibers of the desired sheath/core ratio, based on the weight of each component. The ratio of the polyester component to the polyethylene component in the spunbond fibers was 50:50. The filaments were cooled in a quenching zone with quenching air provided from two opposing quench boxes. The filaments then passed into a pneumatic draw jet where the filaments were drawn and then deposited onto a laydown belt assisted by vacuum suction. The spunbond fabric was then thermally point bonded. The bonding rolls used were heated by hot oil controlled to 121° C. (250° F.), for both rolls. The bonding pressure was set at 250 pounds per linear inch (PLI). Basis weight of the nonwoven layer for these examples was 2.5 oz/yd² (85 g/m²). An uncoated nonwoven layer was used as Comparative Example 1.

A polymer coating was then applied to both sides of the spunbond base fabric. The polymer used for the coating was an ethylene-methylacrylate copolymer sold under the trade name Elvaloy® AC 1609, available from E.I. du Pont de Nemours and Co, Wilmington, Del. with a melting temperature of about 101° C., and a melt flow rate of about 6 g/10 min. Prior to extrusion, the copolymer was heated to 580° F. (304° C.) and extruded onto the spunbond fabric using melt extrusion equipment (manufactured by Egan Davis-Standard, Pawcatuck, Conn.), with an air gap setting of 6.5 in (16.5 cm). Prior to polymer extrusion, the spunbond fabric was subjected to corona treatment, in line with the extrusion die. The polymer coating thickness was controlled by adjusting the line speed of the machine. The coated fabric was wound onto a roll. The fabric was run through the machine in a second pass to coat the opposite side of the fabric.

### Example 11

This example demonstrates the preparation of an underlayment with different coating layers on either side of the nonwoven layer. The nonwoven fabric was prepared as described in Examples 1-10, except that it had a basis weight of 3.5 oz/yd² (119 g/m²) and the fabric had a sheath/core ratio of 30:70. An uncoated nonwoven layer was used as Comparative Example 2. Elvaloy® AC 1609 polymer was applied to the outer layer of the nonwoven as described in Examples 1-10. A UV stabilizing additive package was added to the Elvaloy® AC 1609 layers in this example. Polyethylene having a melt index of 4.5 g/10 min and a density of 0.923 g/cm³ was applied to the inner surface of the nonwoven as described in Examples 1-10.

### Example 12

This example demonstrates the preparation of an underlayment with a coaxial extrusion coating of Elvaloy® AC 1609 and polyethylene on both the inner and outer surfaces of the nonwoven. The nonwoven was prepared as described in Examples 1-10, except that it had a basis weight of 3.5 oz/yd² (119 g/m²), and the sheath-core ratio was 30:70. An uncoated nonwoven layer was used as Comparative Example 3. Polyethylene having a melt index of 7 g/10 min and a density of 0.918 g/cm³ (available from M. Holland Co.) and Elvaloy® AC 1609 were heated in separate extruders, and then co-fed into an extrusion die, and extruded onto the nonwoven as described in Examples 1-10. The coaxial layer was extruded onto the nonwoven such that the polyethylene was in contact with the face of the nonwoven. The ratio of polyethylene to Elvaloy® AC 1609 in each coextruded layer was 75:25 by weight. A UV stabilizing additive package was added to both the polyethylene and the Elvaloy® AC 1609.

### Example 13

This example demonstrates a product where the nonwoven was smooth calendered, instead of point bonded. The nonwoven layer was produced as described in examples 1-10, except that the basis weight of the nonwoven was 3.1 oz/yd² (105 g/m²), and the sheath core ratio was 50:50. An uncoated nonwoven layer was used as Comparative Example 4. In this example, the nonwoven was bonded together by using thermal smooth roll calendering instead of thermal point bond calendering. The smooth calender was run with an oil temperature of 250° F. (121° C.), and 600 pounds per linear inch bonding pressure. The nonwoven fabric was coated on both sides with Elvaloy® AC 1609 polymer, as described in Examples 1-10. A UV stabilizing additive package was added to the Elvaloy® AC 1609.

The coating thickness, coefficient of friction, tensile strength and hydrostatic head are reported for each example in Table 1 and for comparative examples. In the comparative examples:

Triflex-30 is a product of Grace Construction Products, Connecticut.

Tamko® 30 lb. felt is a product of Tamko® Building Products, Incorporated, Joplin, Mo.

ELK Quantum™ is a product of Elk Building Products, Inc., Dallas, Tex.

Titanium™ UDL is a product of InterWrap, Mission, British Columbia, Canada.

EZ-Roof™ Base is a product of Carlisle Coatings and Waterproofing, Inc, Wylie, Tex.

Roofers' Select™ is a product of CertainTeed Corp., Valley Forge, Pa.

TABLE 1

| | Coating | | | Method | |
|---|---|---|---|---|---|
| | Thickness | Coefficient | Tensile | used for | Hydrostatic |
| | Side A/side | of Friction | Strength | Tensile test | Head |
| Example | B (mil)* | (unitless) | MD/CD | Method | cm of water |
| 1 | 1.3/1.0 | 0.42 | 27.3/16.1 (N/cm) | ASTM D412 | 118 |
| 2 | 1.3/1.2 | 0.45 | 28.1/15.8 | ASTM D412 | 151 |
| | | | (N/cm) | | |
| 3 | 1.3/1.4 | 0.42 | 26.5/13.2 | ASTM D412 | 209 |
| | | | (N/cm) | | |
| 4 | 1.3/1.6 | 0.42 | 27.1/16.2 | ASTM D412 | 248 |
| | | | (N/cm) | | |
| 5 | 1.3/1.8 | 0.45 | 28.9/16.9 | ASTM D412 | 327 |
| | | | (N/cm) | | |
| 6 | 1.3/2.0 | 0.34 | 28.7/16.7 | ASTM D412 | 439 |
| | | | (N/cm) | | |
| 7 | 1.3/2.3 | 0.42 | 31.3/18.2 | ASTM D412 | 758 |
| | | | (N/cm) | | |
| 8 | 1.3/2.6 | 0.41 | 26.4/18.9 | ASTM D412 | 788 |
| | | | (N/cm) | | |
| 9 | 1.7/1.7 | — | 30.9/19.0 | ASTM D412 | 693 |
| | | | (N/cm) | | |
| 10 | 1.7/1.9 | — | 32.3/18.1 | ASTM D412 | 514 |
| | | | (N/cm) | | |
| 11 | 1.7/1.5 | 0.42 | 529/362 (N) | ASTM | 754 |
| | | | | D5034-95 | |
| 12 | 1.7/1.7 | 0.39 | 707/496 (N) | ASTM | >1000 (at |
| | | | | D5034-95 | instrument |
| | | | | | upper limit) |
| 13 | 1.7/1.7 | 0.38 | 427/322 (N) | ASTM | >1000 (at |
| | | | | D5034-95 | instrument |
| | | | | | upper limit) |
| Comparative | Uncoated | — | 14.9/5.6 (N/cm, | ASTM D412 | 23 |
| Example 1 | | | delaminated) | | |
| Comparative | Uncoated | — | —/278 (N) | ASTM | — |
| Example 2 | | | | D5034-95 | |
| Comparative | Uncoated | — | 599/403 (N) | ASTM | 33 |
| Examples 3 | | | | D5034-95 | |
| Comparative | Uncoated | — | 224/158 (N) | ASTM | 37 |
| Example 4 | | | | D5034-95 | |
| Comparative | NA | 0.3 | 53/26 (N/cm) | ASTM D412 | 53 |
| Example 5: | | | | | |
| Tamko ® 30 lb. | | | | | |
| Felt | | | | | |
| Comparative | NA | 0.3 | 74/49 (N/cm) | ASTM D412 | 292 |
| Example 6: | | | | | |
| ELK | | | | | |
| Quantum ™ | | | | | |
| Comparative | NA | 0.3 | 19/19 (N/cm) | ASTM D412 | 390 |
| Example 7: | | | | | |
| EZ-Roof ™ | | | | | |
| Base | | | | | |
| Comparative | NA | 0.2 | 84/73 (N/cm) | ASTM D412 | — |
| Example 8: | | | | | |
| Titanium ™ | | | | | |
| UDL | | | | | |
| Comparative | NA | 0.3 | 29/37 (N/cm) | ASTM D412 | 990 |
| Example 9: | | | | | |
| TriFlex-30 | | | | | |
| Comparative | NA | 0.3 | 49/25 (N/cm) | ASTM D412 | 104 |
| Example 10: | | | | | |
| Roofer's | | | | | |
| Select ™ | | | | | |

*1 mil = 0.025 mm.
NA = Not applicable or not available

1. A skid-resistant roof underlayment comprising:
(a) a multiple component spunbond nonwoven web having two major surfaces, the spunbond nonwoven web comprising substantially continuous polymeric sheath-core spunbond fibers wherein the sheath component comprises polyolefin and the core component comprises a polymer selected from the group consisting of polypropylene, polyesters and polyamides, and the weight ratio of the sheath , component to the core component is between about 10:90 and 90:10;
(b) a coating on at least one surface of the spunbond nonwoven web comprising a resin selected from the group consisting of polyethylene, ethylene methyl-acrylate copolymer, ethylene ethyl-acrylate copolymer, and ethylene butyl-acrylate copolymer, wherein the at least one coated surface of the roof underlayment has a coefficient of friction of at least 0.40, the roof underlayment has a tensile strength of at least 26 N/cm in the machine direction and a hydrostatic head of at least 100 cm of water.

2. The roof underlayment of claim 1 wherein the coating is on both major surfaces of the spunbond nonwoven web.

3. The roof underlayment of claim 1 wherein the coating further comprises a UV stabilizer.

4. The roof underlayment of claim 1, wherein the weight ratio of sheath component to core component of the spunbond fibers is between about 50:50 to about 10:90.

5. The roof underlayment of claim 1, wherein the sheath component of the spunbond fibers comprises linear low density polyethylene, and the core component of the spunbond fibers comprises poly(ethylene terephthalate).

6. The roof underlayment of claim 1, wherein the thickness of the coating is between about 1 mil and about 2.5 mil.
